(19) United States
(12) Patent Application Publication
(10) Pub. No.: US 2026/0073523 A1
(43) Pub. Date: Mar. 12, 2026

(54) RADIOGRAPHIC IMAGE ANALYSIS APPARATUS, RADIOGRAPHIC IMAGE PROCESSING METHOD, AND NON-TRANSITORY COMPUTER-READABLE RECORDING MEDIUM STORING RADIOGRAPHIC IMAGE PROCESSING PROGRAM

(71) Applicant: KONICA MINOLTA, INC., Tokyo (JP)

(72) Inventors: Koki TACHI, Tokyo (JP); Kenta SHIMAMURA, Tokyo (JP); Noritsugu MATSUTANI, Tokyo (JP)

(73) Assignee: KONICA MINOLTA, INC., Tokyo (JP)

(21) Appl. No.: 19/324,899

(22) Filed: Sep. 10, 2025

(30) Foreign Application Priority Data
Sep. 12, 2024 (JP) 2024-158234

(51) Int. Cl. G06T 7/00; G06T 7/73

(52) U.S. Cl. CPC G06T 7/0016; G06T 7/74; G06T 2207/10124; G06T 2207/20048; G06T 2207/20224; G06T 2207/30061; G06T 2207/30101

(57) ABSTRACT

A radiographic image analysis apparatus including at least one hardware processor, in which the at least one hardware processor performs: first processing of, for each of a plurality of frame images included in a radiographic dynamic image of a target part of a subject, reducing a component of a structure different from the target part in each of the plurality of frame images; second processing of associating a position in the target part between the plurality of frame images; and analyzing the radiographic dynamic image including the plurality of frame images on which the first processing and the second processing have been performed.

### CROSS REFERENCE TO RELATED APPLICATIONS

The entire disclosure of Japanese Patent Application No. 2024-158234 filed on Sep. 12, 2024 is incorporated herein by reference in its entirety.

### BACKGROUND

### Technological Field

The present invention relates to a radiographic image analysis apparatus, a radiographic image processing method, and a non-transitory computer-readable recording medium storing a radiographic image processing program.

### Description of Related Art

A radiographic image analysis apparatus that performs dynamic analysis on a radiographic image including a plurality of frame images captured by irradiating a target part of a patient with radiation has been known. For example, the radiographic image analysis apparatus performs dynamic analysis on a radiographic dynamic image obtained by imaging the chest of a patient. In this case, since the lungs move due to respiration or the like, the radiographic image analysis apparatus performs alignment called registration between the plurality of frame images so that the dynamic analysis is correctly performed.

For example, in an apparatus disclosed in Japanese Unexamined Patent Publication No. 2023-184215, a first image and a second image obtained by imaging a target part of a patient are arranged in a template space including standard shape information of the target part, and the first image and the second image arranged in the template space are aligned.

Incidentally, as disclosed in Japanese Unexamined Patent Publication No. 2023-184215, when an image in which the chest of a patient is captured is deformed so as to fit in a template space, pixel values of not only the analysis target lung field but also body thickness portions in front of and behind the lung field change. If the pixel values of the body thickness portions before and after the lung field also change, the analysis result of the dynamic analysis is affected, and an inaccurate analysis result may be acquired. For example, in a case where the blood flow of the blood vessel of the lung field is acquired as the analysis result of the dynamic analysis, there is a possibility that a high blood flow value is acquired even when there is a portion where the blood flow is actually decreased.

### SUMMARY

An object of the present invention is to provide a radiographic image analysis apparatus, a radiographic image processing method, and a non-transitory computer-readable recording medium storing a radiographic image processing program, which are capable of acquiring an accurate analysis result even when registration between frame images is performed.

In order to realize at least one of the above-mentioned objects, a radiographic image analysis apparatus reflecting one aspect of the present invention includes at least one hardware processor, in which the at least one hardware processor performs: first processing of, for each of a plurality of frame images included in a radiographic dynamic image of a target part of a subject, reducing a component of a structure different from the target part in each of the plurality of frame images; second processing of associating a position in the target part between the plurality of frame images; and analyzing the radiographic dynamic image including the plurality of frame images on which the first processing and the second processing have been performed.

In order to realize at least one of the above-mentioned objects, a radiographic image processing method by a radiographic image analysis apparatus according to an aspect of the present invention includes: performing first processing of, for each of a plurality of frame images included in a radiographic dynamic image of a target part of a subject, reducing a component of a structure different from the target part in each of the plurality of frame images; performing second processing of associating a position in the target part between the plurality of frame images; and analyzing the radiographic dynamic image including the plurality of frame images on which the first processing and the second processing have been performed.

In order to realize at least one of the above-described objects, a non-transitory computer-readable recording medium storing a radiographic image processing program reflecting an aspect of the present invention is a non-transitory computer-readable recording medium storing a radiation image processing program causing a computer of a radiographic image analysis apparatus to perform: first processing of, for each of a plurality of frame images included in a radiographic dynamic image of a target part of a subject, reducing a component of a structure different from the target part in each of the plurality of frame images; second processing of associating a position in the target part between the plurality of frame images; and analysis processing of analyzing the radiographic dynamic mage including the plurality of frame images on which the first processing and the second processing have been performed.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an explanatory diagram illustrating an example of a configuration of a radiographic image processing system according to an embodiment of the present invention;

FIG. 2 is a block diagram illustrating an example of a functional configuration of an imaging control section in the radiographic imaging system constituting the radiographic image processing system;

FIG. 3 is a block diagram illustrating an example of a functional configuration of the radiographic imaging control apparatus constituting the radiographic image processing system;

FIG. 4 is a block diagram illustrating an example of a functional configuration of the radiographic image analysis apparatus constituting the radiographic image processing system;

FIG. 5 is a functional block diagram illustrating the radiographic image processing method performed by the radiographic image analysis apparatus;

FIG. 6 is a diagram schematically illustrating conventional registration processing;

FIG. 7 is a diagram schematically illustrating the registration processing in the radiographic image processing method illustrated in FIG. 5;

FIG. 8 is a diagram illustrating an analysis result of blood flow obtained by performing dynamic analysis on a dynamic image using conventional registration processing;

FIG. 9 is a diagram illustrating an analysis result of a blood flow obtained by performing dynamic analysis on a dynamic image using the registration processing in the radiation image processing method illustrated in FIG. 5; and

FIG. 10 is a functional block diagram illustrating a variation of the body thickness reduction processing in the radiographic image processing method illustrated in FIG. 5.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, embodiments of the present invention will be described in detail with reference to the drawings.

### Configuration of Radiation Image Processing System

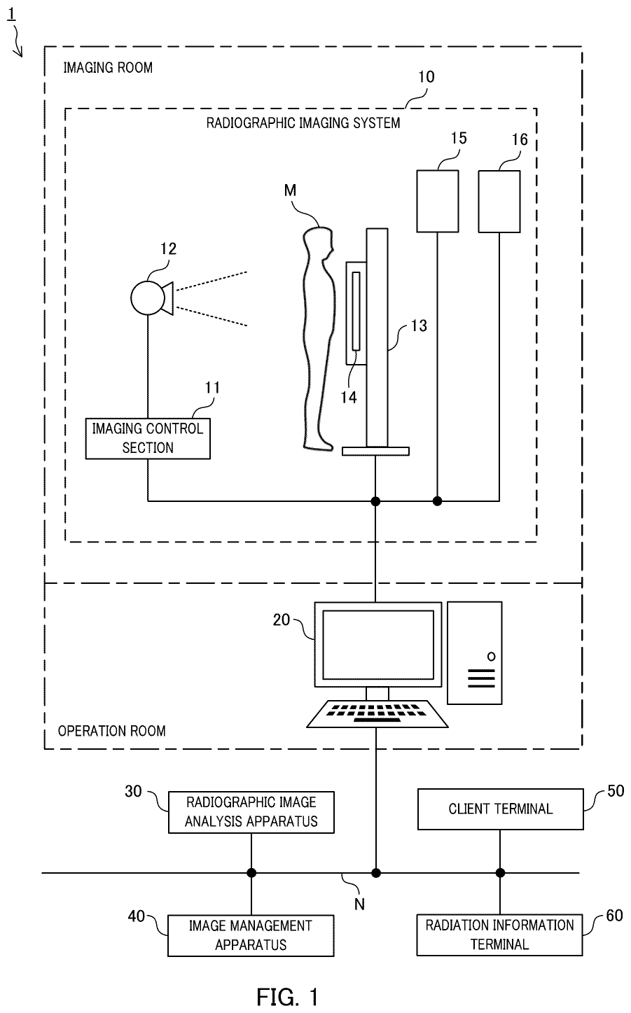

FIG. 1 is a diagram illustrating a radiographic image processing system 1 according to the present embodiment. The radiographic image processing system 1 includes a radiographic imaging system 10, a radiographic imaging control apparatus (console apparatus) 20, a radiographic image analysis apparatus 30, an image management apparatus 40, and a client terminal 50.

In the example illustrated in FIG. 1, the radiographic imaging system 10 is arranged in an imaging room, and the radiographic imaging control apparatus 20 is arranged in an operation room. The radiographic imaging system 10, the radiographic imaging control apparatus 20, the radiographic image analysis apparatus 30, the image management apparatus 40, and the client terminal 50 are connected to each other via a communication network N. As the communication network N, for example, a communication network compliant with the Digital Image and Communications in Medicine (DICOM) standard or the like is used.

Furthermore, the communication network N is connected to a radiation information terminal 60 serving as a radiation information system that transmits information on a radiation examination, for example, examination order information on a patient, to the radiographic image processing system 1. The radiation information terminal 60 is, for example, a radiology information system (RIS).

The radiographic imaging system 10 performs radiographic dynamic imaging (hereinafter referred to as dynamic imaging) which is imaging of a radiographic dynamic image (hereinafter referred to as a dynamic image) on the basis of the control of the radiographic imaging control apparatus 20. The radiographic imaging control apparatus 20 controls the radiographic imaging system 10 on the basis of the examination order information or the like transmitted from the radiation information terminal 60. The dynamic image generated by the radiographic imaging system 10 are processed by the radiographic imaging control apparatus 20, which will be described later, and are transmitted to the radiographic image analysis apparatus 30. The radiographic image analysis apparatus 30 performs dynamic analysis on the dynamic image. The dynamic images and the results of the dynamic analysis are transmitted to and managed by the image management apparatus 40 as a medical image management system. The image management apparatus 40 is, for example, a picture archiving and communication system (PACS). The dynamic image and the result of the dynamic analysis are transmitted to the client terminal 50 and viewed by a healthcare professional such as a doctor.

In the present embodiment, dynamic imaging refers to obtaining a plurality of frame images by repeatedly irradiating a subject with pulsed radiation (for example, X-rays) at a predetermined frame rate (pulse irradiation). The dynamic image refers to a series of frame images obtained by dynamic imaging. Furthermore, the dynamic analysis refers to analysis processing performed on the dynamic image, and includes, in addition to processing for analyzing the movement of the subject based on the dynamic image, processing for analyzing the dynamic image to emphasize or attenuate (remove) a predetermined structure.

Each of the radiographic imaging system 10, the radiographic imaging control apparatus 20, and the radiographic image analysis apparatus 30 is a type of computer that includes a processor and a memory, and realizes a predetermined function by reading, expanding, and executing a program stored in the memory.

### [Radiographic Imaging System 10]

As illustrated in FIG. 1, the radiographic imaging system 10 includes an imaging control section 11, a radiation irradiation section 12, an imaging table 13, a radiation detection section 14, a display section 15, and a sound output section 16.

The imaging control section 11 acquires setting information regarding the setting of the dynamic imaging from the radiographic imaging control apparatus 20. The imaging control section 11 sets imaging condition for dynamic imaging on the basis of the setting information, controls the radiation irradiation section 12 on the basis of the imaging condition to irradiate the patient M (subject) with radiation, and performs imaging. The imaging control section 11 includes a central processing unit (CPU), a random access memory (RAM), a read only memory (ROM), and the like.

The setting information is information on settings for performing dynamic imaging on the patient M. The setting information includes, for example, at least one of a plurality of types of dynamic analyses that can be performed on the dynamic image by the radiographic image analysis apparatus 30. When a plurality of types of dynamic analyses are combined, the setting information may include information on the combination. The setting information is set by an operator of the radiographic image processing system 1, for example, an imaging technician, in the radiographic imaging control apparatus 20 to be described later.

The imaging condition include, for example, various conditions such as a pulse rate, a pulse width, a pulse interval, the number of imaging frames per imaging, a dose per unit time of radiation irradiation, and a body state (a respiratory state or the like) of the patient M. The pulse rate is the number of times of radiation irradiation per second, and matches the frame rate of image data. The pulse width is a radiation irradiation time per radiation irradiation. The pulse interval is a time from the start of one radiation irradiation to the start of the next radiation irradiation, and coincides with a time interval (frame interval) between a plurality of image data. The imaging condition may be automatically determined by the imaging control section 11 of the radiographic imaging system 10 based on the setting information.

The radiation irradiation section 12 is disposed at a position facing the radiation detection section 14 fixed to the imaging table 13. The radiation irradiation section 12 irradiates radiation under the control of the imaging control section 11.

The radiation detector 14 is formed by a semiconductor image sensor, such as a flat panel detector (FPD). The radiation detection section 14 includes a substrate on which a plurality of detection elements (pixels) that detect the radiation irradiated from the radiation irradiation section 12 based on the intensity of the radiation, convert the detected radiation into an electrical signal, and accumulate the electrical signal are arranged in a matrix. Each pixel of the substrate includes, for example, a switching section such as a thin film transistor (TFT).

The radiation detection section 14 controls the switching unit of each pixel based on the image reading condition input from the radiographic imaging control apparatus 20 to read the electrical signal accumulated in each pixel, and outputs intensity information of each pixel to the image generation section 113. The image reading condition is, for example, a frame rate, a frame interval, a pixel size, an image size (matrix size), or the like. The frame rate is the number of frame images acquired per second, and matches the pulse rate. The frame interval is a time period from the start of one operation of acquiring image data to the start of the operation of acquiring the next frame image, and corresponds to the pulse interval.

The imaging control section 11 and the radiation detection section 14 are connected to each other, and exchange synchronization signals with each other so as to synchronize the radiation irradiation operation and the image reading operation.

As described above, under the control of the imaging control section 11, the radiation irradiation section 12 irradiates radiation and the radiation detection section 14 generates image data on the basis of the intensity of the irradiated radiation, and thus the radiographic imaging system 10 performs dynamic imaging of radiographic images.

The display section 15 and the sound output section 16 provide the patient M with instructions on a posture to be taken, a body state, a respiratory state, and the like when dynamic imaging of the patient M is performed. The display section 15 is, for example, a display device such as a cathode ray tube (CRT), a liquid crystal display, or an organic electro luminescence (EL) display. The sound output section 16 is, for example, a sound output device such as a speaker. The sound output section 16 provides the patient M with an instruction on the physical condition, the respiratory condition, or the like by, for example, automated voice. Each of the display section 15 and the sound output section 16 may provide the instruction having the same content to the patient M, or only one of them may provide the instruction.

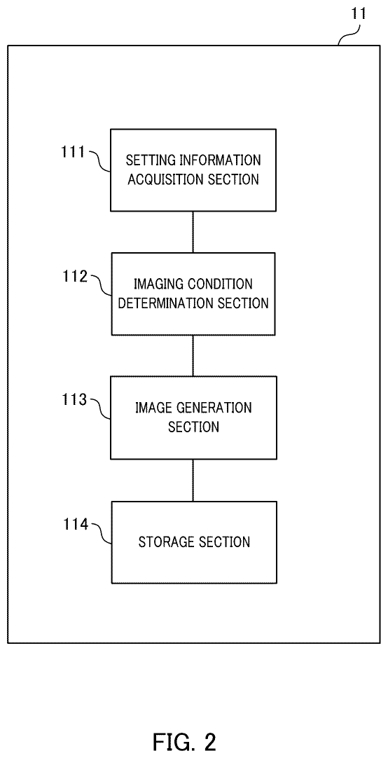

FIG. 2 is a block diagram illustrating an example of a functional configuration of the imaging control section 11 in the radiographic imaging system 10 constituting the radiographic image processing system 1. The imaging control section 11 includes a setting information acquisition section 111, an imaging condition determination section 112, an image generation section 113, and a storage section 114.

The setting information acquisition section 111 acquires setting information from the radiographic imaging control apparatus 20.

The imaging condition determination section 112 determines imaging conditions for performing dynamic imaging of the patient M based on the setting information. Information indicating a correspondence relationship between a plurality of types of dynamic analyses and imaging conditions suitable for the respective dynamic analyses is stored in the storage section 114 in advance. Information indicating a correspondence relationship between a combination of a plurality of types of dynamic analyses and imaging condition suitable for the combination is also stored in the storage section 114 in advance. The imaging condition determination section 112 may determine the imaging condition by reading the information indicating the correspondence relationship from the storage section 114 for the dynamic analysis indicated by the setting information or the combination of the plurality of types of dynamic analyses and collating the information with the setting information.

Note that, for example, in the case of screening, emergency, or the like, the dynamic analysis serving as the setting information may not be set. In such a case, the imaging condition determination section 112 determines the imaging condition by causing the operator to select at least one imaging condition from a plurality of predefined imaging conditions. The imaging condition determination section 112 also allows the operator to select examination order information and determines imaging conditions on the basis of the selected examination order information. As described above, in a case where the dynamic analysis cannot be set before the dynamic imaging, the dynamic analysis is set after the dynamic imaging under the imaging condition selected by the operator, and the dynamic analysis (analysis in the analysis section 314 to be described later) in the radiographic image analysis apparatus 30 to be described later is executed.

The image generation section 113 executes dynamic imaging on the patient M on the basis of the determined imaging condition and generates a plurality of frames of radiographic images. More specifically, the image generation section 113 controls the operations of the radiation irradiation section 12 and the radiation detection section 14 based on the imaging condition, and generates image data by acquiring, for each pixel, intensity information relating to the intensity of radiation transmitted through the subject from the radiation detector 14.

As described above, the storage section 114 stores, in advance, information indicating a correspondence relationship between a plurality of types of dynamic analyses and imaging conditions suitable for the respective dynamic analyses, information indicating a correspondence relationship between combinations of the plurality of types of dynamic analyses and imaging conditions suitable for the combinations, and the like.

### [Radiographic Imaging Control Apparatus 20]

The radiographic imaging control apparatus 20 is, for example, a computer such as a personal computer (PC) or a workstation. The radiographic imaging control apparatus 20 may be a desktop computer as in the example illustrated in FIG. 1, or may be a portable computer such as a notebook computer or a tablet computer.

The radiographic imaging control apparatus 20 receives examination order information from the radiation information terminal 60 or the like and transmits it to the radiographic imaging system 10 to control the dynamic imaging of the radiographic imaging system 10.

The examination order information includes various types of information about dynamic imaging to be performed next, such as instruction information about breathing, patient information, examination information, imaging information, and data attributes. The examination information includes information such as examination IDs, an examination target part (for example, the chest, particularly the lungs, the heart, or the like), and a type of analysis (for example, ventilatory analysis, pulmonary blood flow analysis, measurement of maximal voluntary ventilation, or the like). The examination order information is generated, for example, when a doctor or the like requests the radiographic image processing system 1 to perform dynamic imaging of the patient M.

In addition, the radiographic imaging control apparatus 20 generates setting information indicating at least one dynamic analysis among a plurality of types of dynamic analyses executable by the radiographic image analysis apparatus 30 on the basis of the input of the operator. In the case of combining a plurality of types of dynamic analyses, the radiographic imaging control apparatus 20 generates setting information indicating the combination of the plurality of types of dynamic analyses. The operator recognizes which dynamic analyses to combine among the plurality of types of dynamic analyses by referring to, for example, the content of the examination order information and performs an input operation for generating the setting information on the basis of the recognition. Alternatively, the operator may recognize which dynamic analyses to combine, on the basis of information transmitted from a doctor or the like by another method.

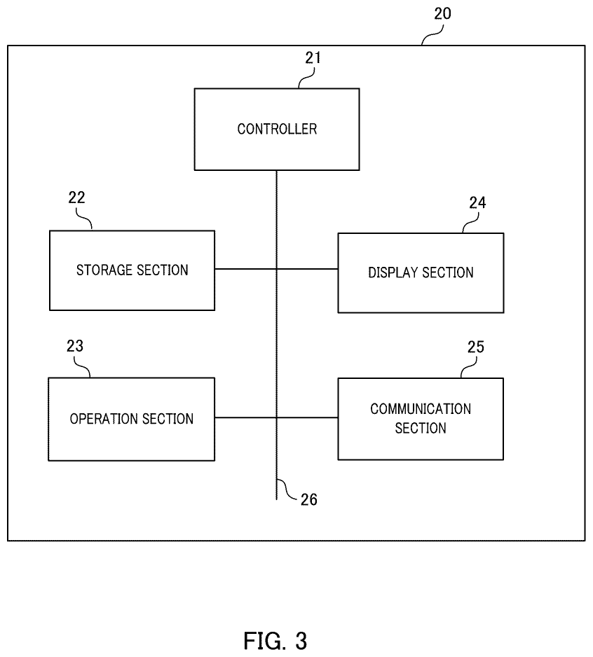

FIG. 3 is a block diagram illustrating an example of a functional configuration of the radiographic imaging control apparatus 20 constituting the radiographic image processing system 1. The radiographic imaging control apparatus 20 includes a controller 21, a storage section 22, an operation section 23, a display section 24, and a communication section 25. The components of the radiographic imaging control apparatus 20 are connected to each other via a bus 26.

The radiographic imaging controller 20 outputs, to the radiographic imaging system 10, setting conditions set by an operator or the like and examination order information acquired in advance from the radiation information terminal 60 or the like, and controls imaging processing by the radiographic imaging system 10. The radiographic imaging control apparatus 20 may display the dynamic image generated by the radiographic imaging system 10, for example, for the operator to confirm it.

The controller 21 includes a CPU, a RAM, and the like. In the controller 21, in response to an operation of the operation section 23, the CPU reads a system program and various processing programs stored in the storage section 22, develops them in the RAM, and controls the operation of each part of the radiographic imaging control apparatus 20 based on the developed programs.

The storage section 22 is configured by a nonvolatile semiconductor memory, a hard disk, or the like. The storage section 22 stores various programs to be executed by the controller 21, parameters required for execution of processing by the programs, or data such as processing results (dynamic images and the like). The various programs are stored in the form of readable program codes, and the controller 21 sequentially executes operations according to the program codes.

Further, the storage section 22 stores image reading condition for performing dynamic imaging. Further, the storage section 22 stores examination order information transmitted from the radiation information terminal 60 or the like. When the radiographic imaging control apparatus 20 controls the dynamic imaging of the radiographic imaging system 10, the radiographic imaging control apparatus 20 reads the image reading condition and the examination order information corresponding to the patient M from the storage section 22 and transmits the read information.

The operation section 23 is an operation device such as a keyboard including cursor keys, number input keys, and various function keys, a pointing device such as a mouse or a trackball, and a touch screen. The operation section 23 generates an instruction signal based on an input of an operator, and outputs the instruction signal to the controller 21.

The display section 24 is constituted by a display device such as a CRT, a liquid crystal display, or an organic EL display. The display section 24 displays an input instruction from the operation section 23, image data (a dynamic image or the like) generated by the radiographic imaging system 10, or the like according to an instruction of a display signal input from the controller 21.

The communication section 25 transmits and receives data to and from the radiographic imaging system 10, the radiographic image analysis apparatus 30, the radiation information terminal 60, and the like.

### [Radiographic Image Analysis Apparatus 30]

The radiographic image analysis apparatus 30 is, for example, a computer such as a PC or a workstation. The radiographic image analysis apparatus 30 may be a desktop computer or a portable computer such as a notebook computer or a tablet computer.

The radiographic image analysis apparatus 30 performs dynamic analysis on the dynamic image captured by the radiographic imaging system 10 based on the setting information set in the radiographic imaging control apparatus 20.

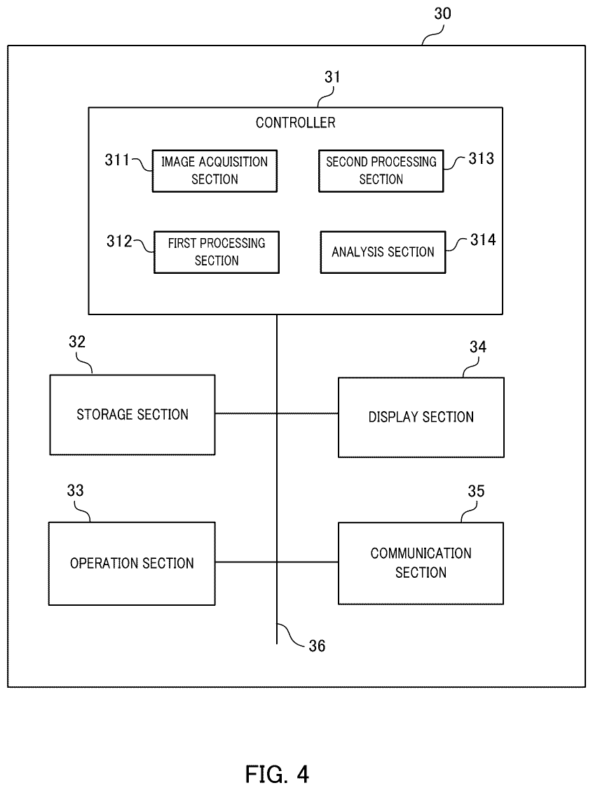

FIG. 4 is a block diagram illustrating an example of a functional configuration of the radiographic image analysis apparatus 30 constituting the radiographic image processing system 1. The radiographic image analysis apparatus 30 includes a controller 31, a storage section 32, an operation section 33, a display section 34, and a communication section 35. These components of the radiographic image analysis apparatus 30 are connected to each other by a bus 36.

The controller 31 is, for example, a computer having at least one hardware processor, and is constituted by a CPU, a RAM, and the like. The radiographic image processing program is stored in a non-transitory computer-readable recording medium, and the storage section 32 stores the radiographic image processing program from the recording medium. In the controller 31, in response to an operation of the operation section 33, the CPU reads a system program and various processing programs stored in the storage section 32, develops them in the RAM, and executes operation control of each part of the radiographic image analysis apparatus 30, dynamic analysis, and the like on the basis of the developed programs. The controller 31 executes, as a processing program, for example, a radiographic image processing program that implements a radiographic image processing method described later.

The controller 31 includes an image acquisition section 311, a first processing section 312, a second processing section 313, and an analysis section 314.

The image acquisition section 311 acquires a dynamic image that is a plurality of frames of radiographic images generated by the radiographic imaging system 10 and the radiographic imaging control apparatus 20.

The first processing section 312 performs, on each of a plurality of frame images included in the dynamic image of the target part of the patient M, first processing of reducing a component of a structure different from the target part of the patient M in the frame image.

The component of the structure different from the target part is a component of a structure other than the target part that overlaps with the target part in the irradiation direction of radiation to the patient M. At this time, the first processing section 312 may perform recognition processing of recognizing a region of the patient M other than the target part as a component of a structure different from the target part and reduce the component of the recognized structure.

Hereinafter, as an example of the component of the structure different from the target part, the component of the body thickness will be described, but the component of the structure different from the target part is not limited to the component of the body thickness, and may include, for example, a component of an artificial object or the like.

As the first processing, the first processing section 312 extracts a body thickness component by, for example, processing of calculating a temporal representative value of a frame image, and subtracts the body thickness component in the frame image from the frame image. In the temporal representative value calculation processing, which will be described in detail later, a representative value in the time direction for each fixed range in the plurality of frame images (e.g., an average value, a median value, a maximum value, or a minimum value of pixel values in the time direction in the plurality of frame images) is calculated as the body thickness component.

Note that the first processing section 312 may perform logarithmic transformation processing on the frame image before the first processing including the temporal representative value calculation processing.

After the first process, the second processing section 313 performs second processing of associating the positions within the target part among the plurality of frame images and matching the coordinates of the associated positions. Specifically, the second processing section 313 causes the coordinates (x, y) of the associated positions to have the same value for each position among the plurality of frame images. Processing of associating positions within a target part among a plurality of frame images and aligning the coordinates of the associated positions is called registration processing.

The second processing section 313 performs, as the second processing, for example, optical flow processing to track each position within the target part over a plurality of frame images and associate each position.

The analysis section 314 performs the dynamic analysis set according to the setting information on the dynamic image including the plurality of frame images on which the first processing and the second processing have been performed, and acquires an analysis result. For example, the analysis section 314 performs analysis based on a signal change in a plurality of frame images. At this time, when the analysis section 314 cannot analyze the dynamic image (cannot acquire the analysis result), the analysis section 314 determines that the analysis is not possible.

The analysis section 314 has, for example, a blood flow analysis mode, a ventilation analysis mode, an adhesion analysis mode, a diaphragm movement amount analysis mode, an orthopedic measurement mode, and the like as the types of dynamic analyses. Each mode will be briefly described below.

The blood flow analysis mode is a mode in which a signal change in the lung field synchronized with the heartbeat is visualized.

The ventilation analysis mode is a mode in which a signal change in a time direction in a specific time-frequency band is extracted and lung tissue behavior during breathing is visualized.

The adhesion analysis mode is a mode for visualizing the degree of adhesion of tissues.

The diaphragm movement amount analysis mode is a mode for tracking the up/down movement of the diaphragm associated with breathing.

The orthopedic measurement mode is, for example, a mode in which a change in the position of a specified bone in the limbs or the like is measured and the trajectory of the movement is displayed.

The storage section 32 is constituted by a nonvolatile semiconductor memory, a hard disk, and/or the like. The storage section 32 stores various programs to be executed by the controller 31, parameters required for execution of processing by the programs, or data such as processing results (e.g., dynamic image and analysis result). The various programs are stored in the form of readable program codes, and the controller 31 sequentially executes operations in accordance with the program codes.

In addition, the storage section 32 stores patient information or examination information related to each dynamic image generated by the radiographic imaging system 10, and list information indicating a status (for example, a progress state such as during reception, during dynamic analysis, or analysis completion). Furthermore, analysis results are stored in the storage section 32 in association with the dynamic image.

The operation section 33 is an operation device such as a keyboard including cursor keys, number input keys, and various function keys, a pointing device such as a mouse or a trackball, and a touch screen. The operation section 33 generates an instruction signal based on an input by the operator, and outputs the instruction signal to the controller 31. The operation section 33 may include a touch screen on the display screen of the display section 34, and in this case, outputs an instruction signal input through the touch screen to the controller 31.

The display section 34 is constituted by a display device such as a CRT, a liquid crystal display, or an organic EL display. The display section 34 displays an input instruction from the operation section 33, image data (a dynamic image, an analysis result, and the like) generated by the radiographic imaging system 10, and the like in accordance with an instruction of a display signal input from the controller 31.

The communication section 35 transmits and receives data to and from the radiographic imaging control apparatus 20, the image management apparatus 40, and the like.

### [Radiographic Image Processing Method]

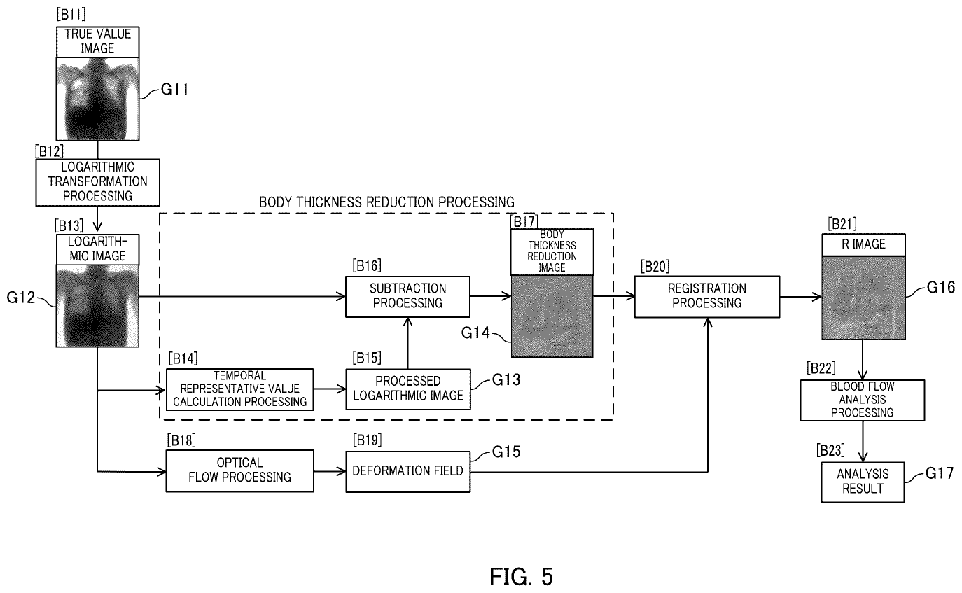

FIG. 5 is a functional block diagram illustrating a radiographic image processing method performed in the radiographic image analysis apparatus 30.

After the radiographic imaging system 10 and the radiographic imaging control apparatus 20 capture the dynamic image of the target part of the patient M, the image acquisition section 311 of the controller 31 of the radiographic image analysis apparatus 30 acquires the dynamic image. The radiographic images of the plurality of frames constituting the dynamic image at this stage are images before the following processing and are referred to as true value images G11 (processed B11).

The first processing section 312 of the controller 31 performs logarithmic transformation processing on each of the true value images G11 to acquire logarithmic images G12 after the logarithmic transformation processing (processing B12 and B13). That is, the first processing section 312 performs logarithmic transformation processing on the true-value images G11 to acquire the logarithmic images G12 before the temporal representative value calculation processing and the optical flow processing described below. Note that the logarithmic transformation processing is not essential, and the subsequent processing can be performed on the true value images G11 as they are, but the accuracy of the processing and the dynamic analysis to be described later is improved by the logarithmic transformation.

The first processing section 312 performs the temporal representative value calculation processing on each logarithmic image G12 to acquire a processed logarithmic image G13 (processes B14 and B15). The logarithmic image G12 is processed with the temporal representative value calculation processing, so that a processed logarithmic image G13 that is an image corresponding to the component (herein, body thickness component) of a structure different from the target part can be obtained.

Here, in the temporal representative value calculation processing, as the body thickness component, a representative value in the time direction for each fixed range is calculated for the plurality of logarithmic images G12. The representative value in the time direction is, for example, a value extracted from within a region having respective widths in the spatial direction and the time direction from a position of interest within one logarithmic image G12 among the plurality of logarithmic images G12. As the temporal representative value calculation processing, processing of calculating, as a representative value, a median value, an average value, a maximum value, a minimum value, or the like of pixel values of the plurality of logarithmic images G12 in an area having arbitrary widths in the time direction and the spatial direction can be used.

Such temporal representative value calculation processing can be performed by using, for example, a three dimensional Median filter. Further, as the process in the process B14, another process in which processing equivalent to the temporal representative value calculation processing is performed may be adopted.

It is desirable that the processed logarithmic image G13 is an image containing as few components of blood flow as possible and as many components of structures different from the target part as possible. In order to remove the component of the blood flow as much as possible, it is desirable that the width in the time direction in the temporal representative value calculation processing is set to a width of an integral multiple of the heartbeat cycle. On the other hand, in order to include as many components of a structure different from the target part as possible, it is desirable to make the width in the time direction as small as possible. Therefore, it is desirable to set the width in the time direction in the temporal representative value calculation processing to a width corresponding to one cardiac cycle. The width in the time direction is a time corresponding to a predetermined number of logarithmic images G12 including one logarithmic image G12 of interest.

Further, it is desirable that the width in the spatial direction in the temporal representative value calculation processing be widened so that the target object is included in the region when the structure different from the target part is moving in the frame image. Thus, even when the structure different from the target part is moving in the frame image, the target object can be included in the region, and the gap between the representative value and the value of the actual image can be reduced.

The first processing section 312 subtracts the corresponding processed logarithmic image G12 from each logarithmic image G13 to acquire a body-thickness-reduced image G14 (processed B16, B17).

The above-described processing B14 to B17 is the first processing in the present invention, that is, the body thickness reduction processing.

The second processing section 313 of the controller 31 performs optical flow processing between the logarithmic images G12 to acquire a deformation field G15 (processing B18 and B19). To be specific, the second processing section 313 executes the optical flow between the logarithmic images G12 adjacent in the time direction. Note that hereinafter, images adjacent in the time direction are referred to as adjacent images. Then, the second processing section 313 obtains, for each small region, corresponding points between adjacent logarithmic images G12 to calculate a motion vector, and acquires a deformation field G15.

The second processing section 313 performs, on the plurality of body-thickness-reduced images G14, registration processing based on the deformation field G15 between the logarithmic images G12 corresponding to the adjacent body-thickness-reduced images G14. That is, the positions in the target part are associated over the plurality of body-thickness-reduced images G14, and the coordinates of the associated positions are aligned to acquire the registration image G16 (processing B20, B21).

The processes B18 to B21 described above are the second process in the present invention.

The analysis section 314 of the controller 31 executes the dynamic analysis set by the setting information, for example, the blood flow analysis mode, on the plurality of registration images G16 after the second processing, and acquires the analysis result G17 for visualizing the signal change in the lung field synchronized with the heartbeat (processing B22, B23).

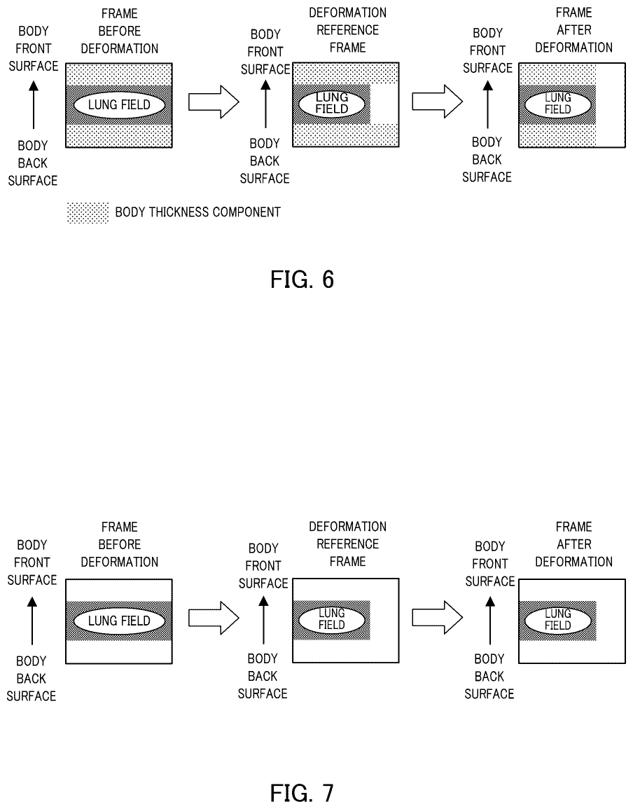

Here, with reference to FIGS. 6 and 7, conventional registration processing and registration processing according to the present invention will be described. FIG. 6 is a diagram schematically illustrating conventional registration processing. FIG. 7 is a diagram schematically illustrating registration processing in the radiographic image processing method illustrated in FIG. 5.

Conventionally, when registration is performed, for example, when registration of a lung field region is performed, a captured frame image (a frame before deformation) is deformed so as to match a deformation reference frame, and alignment is performed (see the left and central diagrams in FIG. 6). For example, in PTL 1 described above, alignment is performed by placing a captured image in a template space including standard shape information of a target part.

In the case where the above-described conventional registration is performed, not only the analysis target lung field but also the body thickness portions in front of and behind the lung field are deformed, and the pixel values of the portions are also changed (see the right diagram in FIG. 6). If the pixel values of the body thickness portions in front and behind the lung field also change, the component of the body thickness portion (body thickness component) affects the dynamic analysis of the lung field portion, and an inaccurate analysis result may be acquired.

Then, in the radiographic image processing method according to the present embodiment, a process of removing the body thickness portion other than the lung field to be analyzed, that is, a process of removing the body thickness component in the image is performed before the registration process. Thus, the frame image after the removal of the body thickness component (the frame before the deformation) is deformed so as to be aligned with the deformation reference frame, and the alignment is performed (see FIG. 7). In this case, since the body thickness component has been removed, the body thickness portions in front of and behind the lung field are not deformed, and the pixel values of the portions do not change. As a result, even if the registration processing is performed, it is possible to suppress the influence of the body thickness component on the dynamic analysis of the lung field portion and acquire a more accurate analysis result.

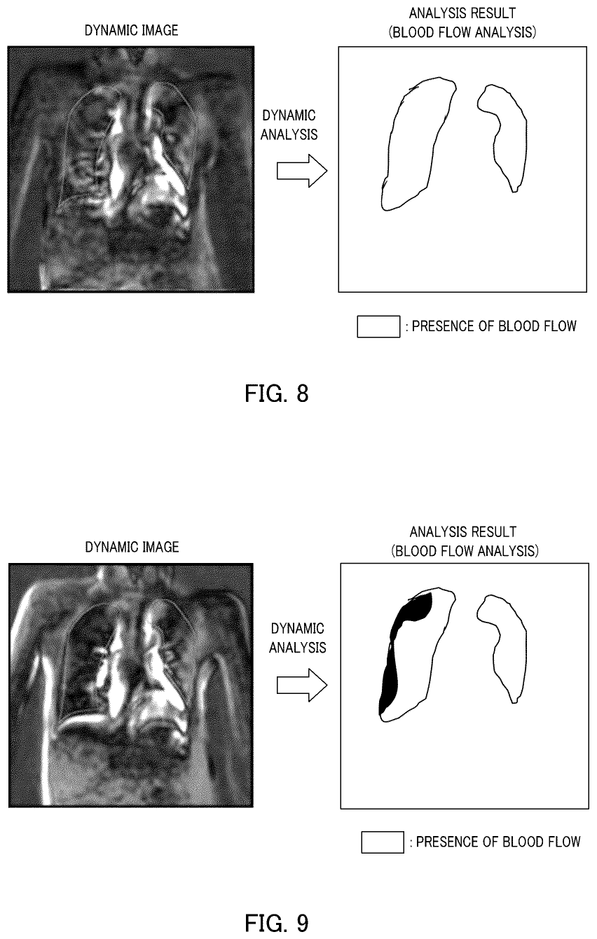

FIG. 8 is a diagram illustrating an analysis result of blood flow obtained by performing dynamic analysis on a dynamic image using conventional registration processing. FIG. 9 is a diagram illustrating an analysis result of blood flow obtained by performing dynamic analysis on a dynamic image using the registration processing in the radiation image processing method illustrated in FIG. 5.

Conventionally, for example, when registration of a lung field region is performed, as described above, there is a possibility that a body thickness component affects dynamic analysis of a lung field portion and an inaccurate analysis result is acquired. For example, in a case where the blood flow in the lung field is acquired by the dynamic analysis, even if there is a portion in which the blood flow is actually lowered, a relatively high blood flow value is acquired, and as illustrated in FIG. 8, there is a possibility that the lowered blood flow portion cannot be visualized as an analysis result.

On the other hand, in the radiographic image processing method according to the present embodiment, as described above, the body thickness component is removed before the registration process, and the influence of the body thickness component on the dynamic analysis of the lung field portion is suppressed. Therefore, for example, in a case where the blood flow of the lung field is acquired by the dynamic analysis, if there is a portion where the blood flow actually decreases, as illustrated in FIG. 9, the portion where the blood flow decreases can be visualized as an analysis result (a black region in FIG. 9), and a more accurate analysis result can be acquired. By referring to the analysis result, the doctor can more accurately evaluate the state of the lung field.

Note that here, the dynamic analysis in the blood flow analysis mode is performed, and the analysis result of the blood flow obtained thereby is illustrated. Not limited to this, for example, the dynamic analysis in the ventilation analysis mode may be performed to acquire the ventilation state (the state of behavior of the lung tissue) as the analysis result.

As described above, the radiographic image analysis apparatus 30 includes the first processing section 312, the second processing section 313, and the analysis section 314. The first processing section 312 performs first processing on each of the plurality of frame images included in the dynamic image of the target part of the patient M to reduce the component of the structure different from the target part in the frame image. After the first processing, the second processing section 313 performs second processing of associating positions in the target part between the plurality of frame images. The analysis section 314 analyzes the dynamic radiographic image including the plurality of frame images on which the first processing and the second processing have been performed.

In this way, the first processing section 312 performs the first processing of reducing the body thickness component of the patient M in each of the plurality of frame images included in the dynamic image. Therefore, the second processing section 313 can perform the second processing of associating the positions in the target part between the plurality of frame images in which the influence of the body thickness component is suppressed. That is, the radiographic image analysis apparatus 30 can acquire a dynamic image in which the influence of the body thickness component is suppressed. As a result, when the second processing (registration processing) is performed, the analysis section 314 performs the dynamic analysis of the dynamic image in which the influence of the body thickness component is suppressed, and thus it is possible to acquire a more accurate analysis result.

The present embodiment is an examination particularly suitable for a patient M who cannot hold his/her breath during imaging, for example, a patient M who is entering an intensive care unit (ICU). It is possible to acquire an analysis result of a blood flow state, a ventilation state, or the like of the lung field of the patient M by performing dynamic imaging on the patient M in a natural breathing state or an artificial breathing state, who cannot hold his/her breath, and by performing the above-described dynamic image processing to perform dynamic analysis. Based on the acquired analysis result, the doctor can diagnose and grasp the state of the lung field of the patient M, for example, the possibility of pulmonary embolism and the respiratory state.

### Variation

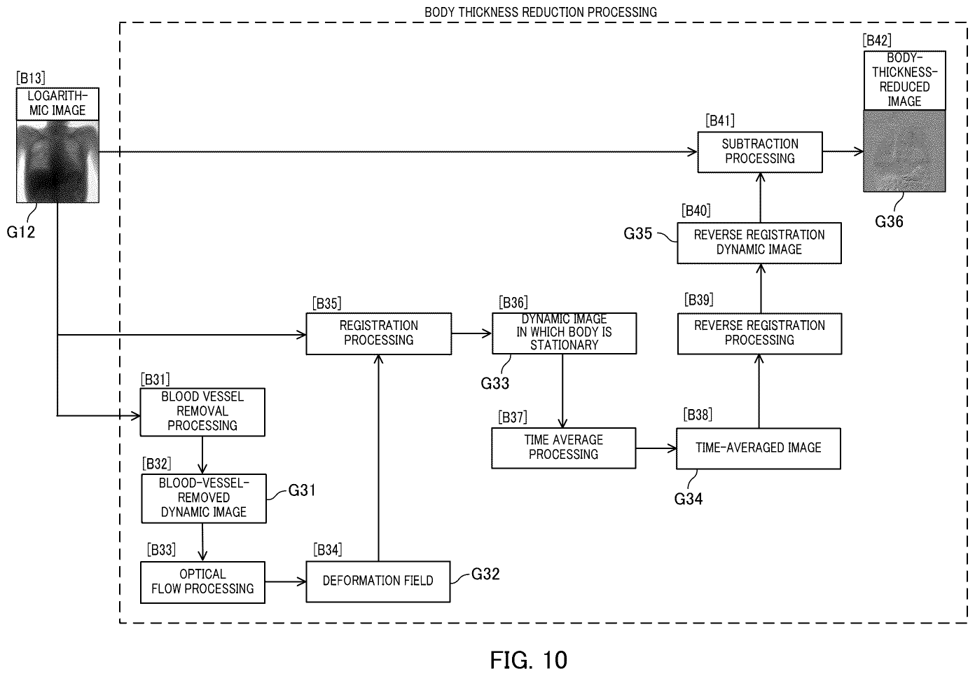

FIG. 10 is a functional block diagram illustrating a variation of the body thickness reduction processing in the radiographic image processing method illustrated in FIG. 5. The body thickness reduction processing may be body thickness reduction processing illustrated in FIG. 10 instead of the body thickness reduction processing in the radiographic image processing method illustrated in FIG. 5. Hereinafter, the body thickness reduction processing of the present variation will be described with reference to FIG. 10.

The first processing section 312 performs blood vessel removal processing on each logarithmic image G12 to acquire a blood-vessel-removed dynamic image G31 (blood-vessel-removed image in the present invention) (processes B31 and B32). For example, the first processing section 312 extracts a portion having a signal change synchronized with the heartbeat from the lung field, determines the extracted portion as a blood vessel, and removes the portion from the logarithmic image G12, thereby performing a blood vessel removal process and acquiring a blood-vessel-removed dynamic image G31.

Note that, in the process B31, processing to remove bony tissue such as clavicles and ribs in addition to the blood vessel may be further performed. For example, in the process B31, bony tissues such as clavicles and ribs are identified one by one in the logarithmic image G12 by analysis or the like using anatomic knowledge of two dimensional X-ray imaging. Then, in the process B31, the signals of the identified osseous tissues are obtained, and processing for removing the osseous tissues is performed by removing (reducing) only the signals.

The first processing section 312 performs optical flow processing between the blood-vessel-removed dynamic images G31, and acquires a deformation field G32 (corresponding information in the present invention) (processing B33 and B34). To be specific, the first processing section 312 executes an optical flow between the adjacent blood-vessel-removed dynamic images G31, obtains, for each small region, corresponding points between the adjacent blood-vessel-removed dynamic images G31 to calculate a motion vector, and acquires a deformation field G32.

The first processing section 312 performs, on the plurality of logarithmic images G12, registration processing based on the deformation field G32 between the blood-vessel-removed dynamic images G31 corresponding to the adjacent logarithmic images G12. That is, the respective positions in the target part are associated over the plurality of logarithmic images G12 to acquire a dynamic image G33 in which the body is stationary (an image in which the body is stationary in the present invention) (processes B35 and B36).

The first processing section 312 performs time averaging processing of calculating one time-averaged image G34 from the dynamic image G33 in which the body is stationary (processes B37 and B38). The blood flow components disappear from the time-averaged image G34.

The first processing section 312 performs inverse registration processing in such a manner that the one time-averaged image G34 is made to follow the movement of the logarithmic image G12 (e.g., made to follow the movement of the lungs in the logarithmic image G12) (processing B39). By the reverse registration process, a reverse registration dynamic image G35 (body thickness image in the present invention) is acquired (process B40). For example, the first processing section 312 may perform inverse registration processing, that is, processing for associating the one time-averaged image G32 with the logarithmic image G34 on the basis of the deformation field G12 described above. As a result, it is possible to create a reverse registration dynamic image G35 (body thickness image) composed of frame images which correspond to the respective frame images of the logarithmic image G12 (for example, which follow the movement of the lungs in the logarithmic image G12) and which do not include blood flow components.

The first processing section 312 subtracts a corresponding frame image in the reverse registration dynamic image G12 (body thickness image) from each frame image of the logarithmic image G35 to acquire a body-thickness-reduced image G36 (processing B41 and B42).

The processing B31 to B42 described above is the first processing in the present variation, that is, the body thickness reduction processing, and it is possible to acquire the body-thickness-reduced image G36 equivalent to or better than that obtained by the processing B14 to B17 described in the above embodiment.

Thereafter, by performing the same processes as the processes B18 to B23 described in the above embodiment, the radiographic image analysis apparatus 30 can acquire a dynamic image in which the influence of the body thickness components is suppressed also in the present variation. As a result, when the second processing (registration processing) is performed, the analysis section 314 performs the dynamic analysis of the dynamic image in which the influence of the body thickness component is suppressed, and thus it is possible to acquire a more accurate analysis result.

The above-described embodiments are merely examples for implementing the present invention, and the technical scope of the present invention should not be interpreted in a limited manner by these embodiments. That is, the present invention can be implemented in various forms without departing from the spirit or main features thereof.

For example, in the above-described embodiment, the radiographic image analysis apparatus 30 includes the first processing section 312, but the radiographic imaging control apparatus 20 may include the first processing section 312. In this case, the radiographic imaging control apparatus 20 performs the first processing by the first processing section 312, and the radiographic image analysis apparatus 30 performs the second processing by the second processing section 313.

Although embodiments of the present invention have been described and illustrated in detail, the disclosed embodiments are made for purpose of illustration and example only and not limitation. The scope of the present invention should be interpreted by terms of the appended claims.

What is claimed is:

1. A radiographic image analysis apparatus comprising at least one hardware processor, wherein
the at least one hardware processor performs:
first processing of, for each of a plurality of frame images included in a radiographic dynamic image of a target part of a subject, reducing a component of a structure different from the target part in each of the plurality of frame images;
second processing of associating a position in the target part between the plurality of frame images; and
analyzing the radiographic dynamic image including the plurality of frame images on which the first processing and the second processing have been performed.

2. The radiographic image analysis apparatus according to claim 1, wherein
the at least one hardware processor performs registration processing of matching coordinates of the associated position on the plurality of frame images on which the second processing has been performed.

3. The radiographic image analysis apparatus according to claim 1, wherein
the at least one hardware processor performs analysis based on a signal change in the plurality of frame images included in the radiographic dynamic image.

4. The radiographic image analysis apparatus according to claim 1, wherein
the at least one hardware processor performs analysis related to blood flow of the subject.

5. The radiographic image analysis apparatus according to claim 1, wherein
the target part is a lung field, and
the at least one hardware processor performs processing of analyzing blood flow in the lung field.

6. The radiographic image analysis apparatus according to claim 1, wherein
the target part is a lung field, and
the at least one hardware processor performs processing of analyzing a ventilation state of the lung field.

7. The radiographic image analysis apparatus according to claim 1, wherein
the at least one hardware processor subtracts, as the first processing, the component of the structure different from the target part in each of the plurality of frame images, from each of the plurality of frame images.

8. The radiographic image analysis apparatus according to claim 1, wherein
the component of the structure is a component of a structure located at a position overlapping with the target part in a direction in which radiation is irradiated to the subject.

9. The radiographic image analysis apparatus according to claim 1, wherein
the at least one hardware processor performs recognition processing of recognizing a part of the subject other than the target part as the component of the structure, and reduces the recognized component of the structure.

10. The radiographic image analysis apparatus according to claim 1, wherein
the at least one hardware processor subtracts a representative value in a time direction in the plurality of frame images, from each of the plurality of frame images.

11. The radiographic image analysis apparatus according to claim 10, wherein
the representative value in the time direction is an average value, a median value, a maximum value, or a minimum value of pixel values in the time direction in the plurality of frame images.

12. The radiographic image analysis apparatus according to claim 1, wherein
the at least one hardware processor subtracts a representative value in a time direction per fixed range in the plurality of frame images, from each of the plurality of frame images.

13. The radiographic image analysis apparatus according to claim 12, wherein
the representative value is a value extracted from an area having widths in a spatial direction and a time direction from a position of interest in one frame image of the plurality of frame images, and
the width in the time direction is a time corresponding to a predetermined number of frame images including the one frame image.

14. The radiographic image analysis apparatus according to claim 13, wherein
the width in the time direction is a time corresponding to one cycle of a heartbeat.

15. The radiographic image analysis apparatus according to claim 14, wherein
the representative value in the time direction per fixed range is an average value, a median value, a maximum value, or a minimum value in the time direction.

16. The radiographic image analysis apparatus according to claim 1, wherein
the at least one hardware processor performs logarithmic transformation processing on the plurality of frame images before the first processing.

17. The radiographic image analysis apparatus according to claim 7, wherein
the at least one hardware processor performs:
processing of removing blood vessels in a lung field of the subject in the plurality of frame images from the plurality of frame images to acquire a blood-vessel-removed image;
processing of acquiring correspondence information for associating a position in the target part by tracking the position over a plurality of the blood-vessel-removed images, associating the position in the target part over the plurality of frame images based on the correspondence information, and acquiring an image in which a body is stationary;
processing of calculating a time-averaged image from the image in which the body is stationary;
reverse registration processing of creating a body thickness image corresponding to the plurality of frame images by performing processing of associating the time-averaged image with the plurality of frame images; and
processing of subtracting the body thickness image corresponding to the plurality of frame images from the plurality of frame images and acquiring a body-thickness-reduced image with a body thickness component subtracted.

18. The radiographic image analysis apparatus according to claim 1, wherein
the at least one hardware processor performs, as the second processing, tracking of a position in the target part over the plurality of frame images to associate the position.

19. The radiographic image analysis apparatus according to claim 18, wherein
the at least one hardware processor associates the position in the target part using optical flow processing.

20. A radiographic image processing method by a radiographic image analysis apparatus, comprising:
performing first processing of, for each of a plurality of frame images included in a radiographic dynamic image of a target part of a subject, reducing a component of a structure different from the target part in each of the plurality of frame images;
performing second processing of associating a position in the target part between the plurality of frame images; and
analyzing the radiographic dynamic image including the plurality of frame images on which the first processing and the second processing have been performed.

21. A non-transitory computer-readable recording medium storing a radiographic image processing program causing a computer of a radiographic image analysis apparatus to perform:
first processing of, for each of a plurality of frame images included in a radiographic dynamic image of a target part of a subject, reducing a component of a structure different from the target part in each of the plurality of frame images;
second processing of associating a position in the target part between the plurality of frame images; and
analysis processing of analyzing the radiographic dynamic mage including the plurality of frame images on which the first processing and the second processing have been performed.
